(19) United States
(12) Patent Application Publication
(10) Pub. No.: US 2025/0079490 A1
(43) Pub. Date: Mar. 6, 2025

(54) Phosphoric Acid Replenishment

(71) Applicant: ZeroAvia Ltd., Gloucestershire (GB)

(72) Inventors: Sergei SHUBENKOV, Canterbury (GB); Bob L. MACKEY, San Jose, CA (US)

(73) Assignee: ZeroAvia Ltd., Gloucestershire (GB)

(21) Appl. No.: 18/240,769

(22) Filed: Aug. 31, 2023

(51) Int. Cl. H01M 8/086; H01M 8/0258; H01M 8/0267

(52) U.S. Cl. CPC H01M 8/086; H01M 8/0258; H01M 8/0267; H01M 2300/0008

(57) ABSTRACT

The invention of the current application is directed to a cooling spray system and method for a high temperature proton exchange membrane (HTPEM) fuel cell including a HTPEM fuel cell including a cathode and an anode, a liquid sprayer, and a storage vessel containing a mixture of water and electrolyte. The storage vessel is in fluid communication with the liquid sprayer and the liquid sprayer is positioned to spray the mixture of water and electrolyte into the air supply of the cathode.

### BACKGROUND

The present disclosure relates to fuel cell systems and method for operating same. The disclosure has particular utility in the creation of high temperature proton exchange membrane (HTPEM) fuel cells for use in fuel cell powered vehicles, including aircraft, and will be described in connection with such utility, although other utilities are contemplated including, by way of example, backup power generation and portable power systems.

A fuel cell is an electrochemical cell that converts chemical energy into electrical energy by means of spontaneous electrochemical reduction-oxidation (redox) reactions. Fuel cells include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Fuel cells may be used as power sources for electric motors of electric vehicles and hybrid electric vehicles, including aircraft. In such applications, fuel cells are oftentimes arranged in stacks of multiple cells and connected in a series or parallel arrangement to achieve a desired power and output voltage. Cooling systems for fuel cell-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle. An airflow generated in this manner is oftentimes referred to as ram air and, when ram air is used as a cooling medium in a vehicle, the vehicle may experience increased drag, which may reduce the energy efficiency of the vehicle.

Heat management processes such as heat exchangers or coolant media in high temperature polymer electrolyte membrane (HTPEM) fuel cells increase the overall weight and volume of the system. Improvements in cooling efficiency directly impact cost per kilowatt (kW) and enable operation at higher altitudes.

Applicants hereby incorporate by reference GB application number 2305991.8, filed Apr. 24, 2023, and entitled Turbo-Evaporative Cooled HTPEM Fuel Cell System.

Applicants hereby incorporate by reference the disclosure of RU 2467435 titled, “Fuel element system with evaporation cooling, and operating method of such system.” This disclosure relates to evaporative cooling system for a PEM fuel cell in aviation application but not high temperature so not using phosphoric acid (PA).

Applicants hereby incorporate by reference the disclosure of Ivana Matanovic, Albert S. Lee, and Yu Seung Kim, “Energetics of Base Acid Pairs for the Design of High-Temperature Fuel Cell Polymer Electrolytes,” The Journal of Physical Chemistry B 2020 124 (35), 7725-7734

DOI: 10.1021/acs.jpcb.0c05672. The study in this disclosure suggests that incoming water can accelerate the PA loss at the initial stage as water replaces the PA molecules in the membrane.

Applicants hereby incorporate by reference the disclosure of Katie H. Lim, Ivana Matanovic, Sandip Maurya, Youngkwang Kim, Emory S. De Castro, Ji-Hoon Jang, Hyounmyung Park, and Yu Seung Kim, “High Temperature Polymer Electrolyte Membrane Fuel Cells with High Phosphoric Acid Retention,” ACS Energy Letters 2023 8 (1), 529-536, DOI: 10.1021/acsenergylett.2c02367. This reference discusses quaternary ammonium-biphosphate ion-pair to delay the water replacement mechanism in HTPEM Fuel Cells (FCs) but not applying water spray-cooling.

Cooling of HTPEM fuel cells is a challenge. High specific power output requires increases in cooling. Water spray has been used at the ram air inlet in other cooling applications. However, this has not heretofore been practical with HTPEM because when water spray cools the cathode, phosphoric acid (PA), or H₃PO₄, can be depleted from the cathode by entrainment with the water mist. Depletion of phosphoric acid electrolytes reduces the current carrying capacity of an electrolyte membrane. Because of this, water spray cooling of the cathode in a HTPEM FC has been considered impossible or at best not an optimal solution.

### SUMMARY OF THE INVENTION

The invention of the current application combines an electrolyte, typically phosphoric acid, in a cooling water spray such that the cooling spray composition replenishes the cathode electrolytes. Replenishing the electrolyte, for example, phosphoric acid, allows the fuel cell to continue operating at high power density. This adds substantially more cooling capability so that, when optimized, the electrically-isolated coolant passages may be deleted, simplifying fuel-cell manufacturing while also reducing weight and complexity of the fuel cell system. In some embodiments, the cooling spray composition is optimized such that the amount of phosphoric acid added equals the amount removed by the cathode exhaust stream. In some embodiments, by replacing the electrolyte that could be removed by water spray, continuous high-power operation of the HTPEM is provided while also utilizing evaporative cooling in the cathode.

The embodiments of the current application replenish the electrolyte, e.g., phosphoric acid (PA), that is removed from the cathode by adding a similar amount of electrolyte, e.g., PA, to the cathode via an air inlet water spray along with the cathode air supply. Phosphoric acid is a commonly used electrolyte in HTPEM fuel cells, but other acids may be used to enable proton transport in the membrane. When the electrolyte-incorporated water droplets come into contact with the cathode surface, there is no net transport of electrolyte to or from the cathode because the two liquids that come into contact are of similar concentrations.

The amount of electrolyte in the spray is that which is sufficient to account for the amount of electrolyte depleted by electrolyte loss at the cathode outlet. In some embodiments, the electrolyte depletion is monitored by continuous measurement of exhaust water droplet conductivity. The electrolyte loss measured by this method is used to control the amount of electrolyte added to the coolant water spray. In another embodiment, the electrolyte concentration in the fuel cell membranes is measured and monitored. The measurement may be electrical, such as DC conductance or AC impedance, or other measurement methods may be employed such as spectroscopic analysis. In some embodiments, the electrolyte concentration in the spray matches the electrolyte concentration in the cathode. Typically, the phosphoric acid electrolyte concentration in the HTPEM cathode is 10-15 Mol/L.

The measured electrolyte concentration in the fuel cell membrane is used to control the amount of electrolyte added to the water spray. In this way, the electrolyte concentration in the membranes is regulated and controlled to allow optimal fuel cell performance. In aircraft applications, an optimum amount may be the concentration that allows for the highest power density. In other applications, the maximum efficiency may be considered optimal.

A control system that regulates the electrolyte concentrations may require two or more concentrations of the electrolyte to be stored for mixing on demand. A high-concentration electrolyte in one tank and pure water in a second tank allows proportional mixing to achieve the desired concentration at the sprayer.

The control system may be interfaced with aircraft flight controls and flight management software to provide predictive power requirements. The electrolyte replacement rate can then be controlled in anticipation of changes in airflow or electrolyte depletion.

Electrolyte, for example PA, can be moderately corrosive, so in some embodiments, all components in contact with the acid are corrosion resistant, for example, stainless steel, polyethylene, glass, etc.

In some embodiments, the amount of water in the spray should be sufficient to carry heat away by evaporation and convective transport. Hydrogen fuel cells often operate at approximately 50% efficiency. For each kilowatt of electricity produced, about one kilowatt of heat must be dissipated. To dissipate that thermal energy via evaporation of water, 1.64 kg of water is evaporated for each kilowatt hour (kWh) of heat energy. To provide uniform cooling of the cathode, excess water is desired. Hence, in some embodiments 2 kg of water may be passed through the cathode along with air to provide evaporative cooling for each kilowatt hour of heat to be removed.

In some embodiments, to achieve temperature uniformity, there must be liquid water present across the full width of the cathode. In some embodiments water droplets are entrained in the cooling air flow at the cathode air exit. In some embodiments, because the water can dissolve electrolyte from the cathode surface, the electrolyte may be carried away from the cathode along with the water droplets. In some embodiments, the electrolyte may be collected at a separator downstream from the cathode exhaust. In some embodiments, an anode tail oxidizer (ATO) is used to combust hydrogen remaining in the anode exhaust with remaining oxygen in the cathode exhaust. The heat generated typically fully evaporates the liquid water, leaving the electrolyte as a solid. The ATO can be rinsed to reclaim the electrolyte.

In some embodiments, the separator is placed before the ATO to minimize the amount of electrolyte deposited in the ATO. In other embodiments, the separator is integral with the ATO, and rinsing the ATO is the mechanism to reclaim the electrolyte.

In some embodiments, the ATO is placed downstream of the fuel cell and configured to combust unburned hydrogen gas exiting the fuel cell and passing the exhaust from the ATO to a turbine.

In some embodiments, exhaust from the ATO is passed through a separator, for example, a centrifugal separator, to extract the remaining liquid water droplets from the water-air mixture, and the extracted water can be recycled to an electrolyte and water storage vessel, for example a tank, which feeds the spray nozzles.

In some embodiments, a cooling spray system for a high temperature proton exchange membrane (HTPEM) fuel cell including:
an HTPEM fuel cell comprising a cathode and an anode;
a sprayer; and
a storage vessel containing a water and electrolyte mixture,
   wherein the storage vessel is in fluid communication with the sprayer and
   wherein the sprayer is positioned to spray the mixture of water and electrolyte into the air supplied to the cathode.

In some embodiments, the electrolyte concentration in the mixture of water and electrolyte is 10-15 Mol/L.

In some embodiments, the electrolyte is phosphoric acid.

In some embodiments, an electrolyte concentration in the mixture of water and electrolyte is less than or equal to an electrolyte concentration in the cathode.

In some embodiments, the electrolyte concentration in the mixture of water and electrolyte is regulated by a control system to maintain a constant level of electrolyte in a fuel cell membrane.

In some embodiments, the electrolyte concentration is measured in the fuel cell membrane.

In some embodiments, the measurement is provided by at least one of DC conductance, AC impedance, and/or spectroscopic analysis.

Some embodiments additionally include an anode tail oxidizer (ATO) wherein the ATO is in fluid communication with the cathode.

Some embodiments additionally include a separator wherein the separator is positioned downstream from the cathode and collects electrolyte from the cathode exhaust.

In some embodiments, the separator is a centrifugal separator.

Some embodiments additionally include a compressor in gas communication with the sprayer.

Some embodiments include a method for cooling a high temperature proton exchange membrane (HTPEM) fuel cell including the following:
spraying into the air supply of a cathode of the HTPEM fuel cell with a mixture of water and electrolyte.

In some embodiments, the electrolyte is phosphoric acid.

In some embodiments, an electrolyte concentration in the water and electrolyte mixture is regulated by a controller to control the amount of electrolyte in the fuel cell membranes.

Some embodiments additionally include combusting the cathode exhaust with the anode exhaust.

Some embodiments additionally include separating a mixture of liquid water and electrolyte from air and recycling the mixture of liquid water and electrolyte to a storage vessel which is in fluid communication with the sprayer.

In some embodiments, the electrolyte concentration in the mixture of water and electrolyte is 10-15 Mol/L.

In some embodiments, 2 kg of water is passed through the cathode along with air for each kilowatt-hour of electricity produced.

In some embodiments, heated exhaust from combusting the cathode exhaust with the anode exhaust is delivered to a turbine which recovers energy from the heated exhaust.

### BRIEF DESCRIPTION OF THE DRAWINGS

FIG. 1 depicts an electrolyte incorporated water spray stream in accordance with the present disclosure.

FIG. 2 depicts an anode tail oxidizer reclamation stream for electrolyte where air exits from the center of a separator flow while liquid water and electrolyte exit from the perimeter.

FIG. 3 depicts an HTPEM fuel cell system that includes a cooling water spray and sensors.

FIG. 4 depicts a flowchart for operation of an HTPEM fuel cell system with electrolyte replenishment in accordance with the present disclosure.

### DETAILED DESCRIPTION OF THE DRAWINGS

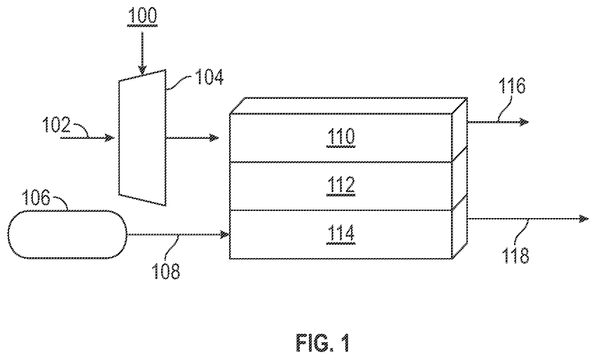

FIG. 1 shows a simplified example of how an electrolyte is incorporated into a cooling spray system in which a water spray stream is used to cool a cathode in an HTPEM fuel cell 112. The water and electrolyte mixture 100 is combined and then input into a sprayer 104 along with compressed air. The sprayer 104 distributes the water and electrolyte mixture into the cathode supply air. The air with entrained water and electrolyte passes through the cathode 110, supplying oxygen, absorbing heat, and replenishing any electrolyte that might be carried away in the cathode exhaust air. Wet air with electrolyte 116 exits the cathode 110 on the other side. Additionally, hydrogen 108 enters the anode 114 from a hydrogen storage tank 106 and the anode's 114 hydrogen exhaust 118 exits the other side.

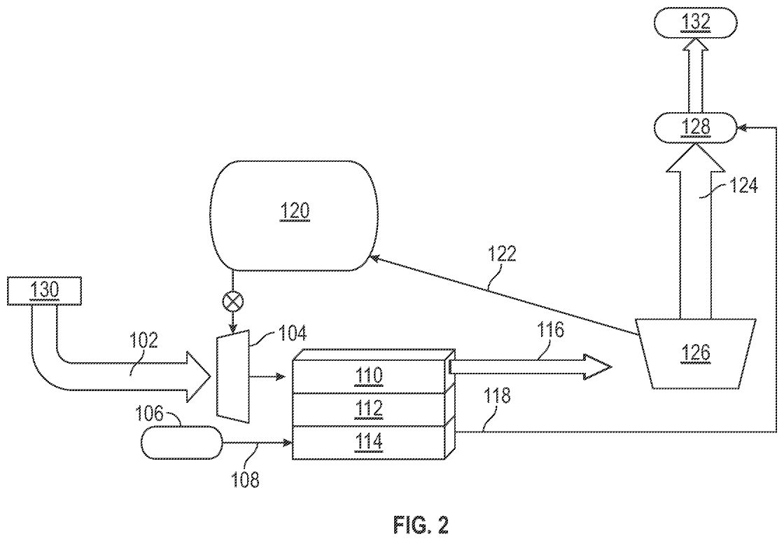

FIG. 2 shows an anode tail oxidizer reclamation stream for electrolyte where air 124 exits from the center of a separator 126 flow while liquid water and electrolyte 122 exit from the perimeter. Specifically, water and electrolyte mixture 100 (FIG. 1) is provided to a sprayer 104 from a storage vessel 120, for example a tank. Compressed air 102 is also provided to the sprayer 104 via, for example a compressor 130. The sprayer 104 then delivers the electrolyte and water mixture 100 over the surface of the cathode 110 and wet air with electrolyte 116 exits the cathode 110 on the other side. Additionally, hydrogen 108 enters the anode 114 from a hydrogen storage tank 106, and the anode's 114 hydrogen exhaust 118 exits the other side.

Upon their exit from the cathode, the wet air with electrolytes is collected by separator 126. The liquid 122 containing a mixture of water and electrolyte is delivered to tank 120. The exhaust air 124 is delivered to an anode tail oxidizer (ATO) 128, along with hydrogen 118 from anode 114. The ATO combusts the hydrogen and air. The heated exhaust from the ATO can be then delivered to a turbine 132 to recover some of the energy from the heated exhaust. A separator 126 then extracts the remaining liquid water droplets from the water/electrolyte-air mixture, and the extracted water/electrolyte 122 is recycled to the storage vessel 120.

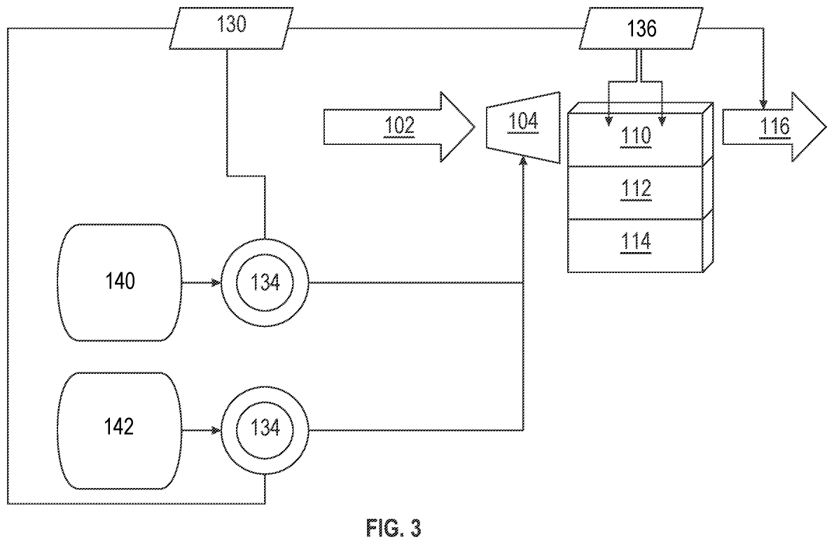

FIG. 3 depicts an HTPEM fuel cell system that includes a cooling water spray 104 and sensors 136 which monitor electrolyte concentrations in the fuel cell cathode 110, and optionally in the fuel cell exhaust. A controller 130 is configured to control the addition of electrolyte, typically H₃PO₄, from storage vessel 140 and water from storage vessel 142 to the cooling water spray 104. Compressed air 102 may also be provided to the sprayer 104. Water may also be added as needed to control the fuel cell temperature. Electrolyte is added as needed to control the electrolyte concentration in the fuel cell. The controller 130 regulates the mixing and spray by control of pumps and/or valves 134.

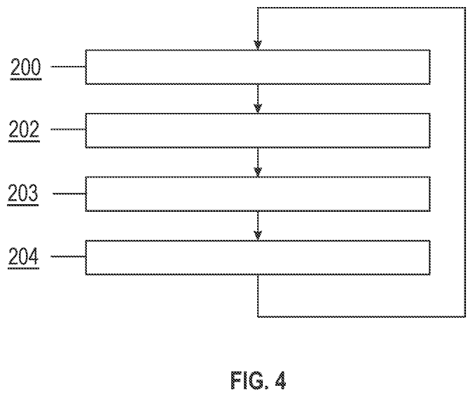

FIG. 4 depicts a typical operating method for adding electrolyte to an operating HTPEM FC. A series of steps is repeated. In step 200, the electrolyte concentration is measured. This can include direct measurement of the electrolyte concentration within the fuel cell membrane, or indirect measurement such as a measurement of the amount of electrolyte removed with the cathode exhaust. In step 202 an amount of electrolyte is determined for addition to the fuel cell. The electrolyte is dispensed in step 203 and directed to the fuel cell via the sprayer in step 204.

Without further elaboration, it is believed that one skilled in the art can, using the preceding description, utilize the present invention to its fullest extent. The preceding referenced specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A cooling spray system for a high temperature proton exchange membrane (HTPEM) fuel cell comprising:
an HTPEM fuel cell comprising a cathode and an anode;
a sprayer; and
a storage vessel containing a water and electrolyte mixture,
wherein the storage vessel is in fluid communication with the sprayer and
wherein the sprayer is positioned to spray the mixture of water and electrolyte into the air supplied to the cathode.

2. The cooling spray system of claim 1, wherein electrolyte concentration in the mixture of water and electrolyte is 10-15 Mol/L.

3. The cooling spray system of claim 1, wherein the electrolyte is phosphoric acid.

4. The cooling spray system of claim 1, wherein an electrolyte concentration in the mixture of water and electrolyte is less than or equal to an electrolyte concentration in the cathode.

5. The cooling spray system of claim 4, wherein the electrolyte concentration in the mixture of water and electrolyte is regulated by a control system to maintain a constant level of electrolyte in a fuel cell membrane.

6. The cooling spray system of claim 5, wherein the electrolyte concentration is measured in the fuel cell membrane.

7. The cooling spray system of claim 6, wherein the measurement is provided by at least one of DC conductance, AC impedance, and/or spectroscopic analysis.

8. The cooling spray system of claim 1, additionally comprising an anode tail oxidizer (ATO) wherein the ATO is in fluid communication with the cathode.

9. The cooling spray system of claim 1, additionally comprising a separator wherein the separator is positioned downstream from the cathode and collects electrolyte from the cathode exhaust.

10. The cooling spray system of claim 9, wherein the separator is a centrifugal separator.

11. The cooling spray system of claim 1, additionally comprising a compressor in gas communication with the sprayer.

12. A method for cooling a high temperature proton exchange membrane (HTPEM) fuel cell comprising:
spraying into the air supply of a cathode of the HTPEM fuel cell with a mixture of water and electrolyte.

13. The method of claim 12 wherein the electrolyte is phosphoric acid.

14. The method of claim 12 wherein an electrolyte concentration in the water and electrolyte mixture is regulated by a controller to control the amount of electrolyte in the fuel cell membranes.

15. The method of claim 12 additionally comprising combusting the cathode exhaust with the anode exhaust.

16. The method of claim 12 additionally comprising separating a mixture of liquid water and electrolyte from air and recycling the mixture of liquid water and electrolyte to a storage vessel which is in fluid communication with the sprayer.

17. The method of claim 12 wherein the electrolyte concentration in the mixture of water and electrolyte is 10-15 Mol/L.

18. The method of claim 12 wherein 2 kg of water is passed through the cathode along with air for each kilowatt-hour of electricity produced.

19. The method of claim 15 wherein heated exhaust from combusting the cathode exhaust with the anode exhaust is delivered to a turbine which recovers energy from the heated exhaust.
